(19) United States
(12) Patent Application Publication
(10) Pub. No.: US 2009/0055207 A1
(43) Pub. Date: Feb. 26, 2009

(54) Interactive bridal planner

(76) Inventors: Victoria Suarez, Clarks Summit, PA (US); Chavdar Petkov, Scranton, PA (US)

Correspondence Address: VICTORIA SUAREZ, 201 LACKAWANNA AVENUE, SUITE 225, SCRANTON, PA, 18503, US

(21) Appl. No.: 11/894,958

(22) Filed: Aug. 22, 2007

(51) Int. Cl. G06Q 90/00

(52) U.S. Cl. 705/1

(57) ABSTRACT

An interactive wedding planner incorporates a number of interactive tabs to keep track of schedules, guest lists, budgets, vendor information, publications and personal notes. It also has the ability to allow communication between users and provides e-mail support. The planner provides a modular general plan complete with deadlines and estimates costs. The user personalizes the general plan to create a personal plan which guides the user through the process. Ongoing actual data is provided to the system to provide reminders and reports of how the user is doing compared to their personal plan. The planner also keeps track of responses of people attending and extrapolates the total number of people attending. It then performs calculations based upon the extrapolated total number attending.

### CROSS REFERENCE TO RELATED APPLICATIONS

The present application claims priority from U.S. Provisional Patent Application “Interactive Bridal Planner”, Ser. No. 60/839,013 filed Aug. 21, 2006 by the same inventive entity as the present application, and incorporates all subject matter of the Provisional Patent Application as set forth in its entirety herein.

### BACKGROUND OF THE INVENTION

1. Field of the Invention

The present invention relates to an on-line system for planning and managing a wedding.

2. Discussion of Related Art

Planning a wedding is similar to running a large scale project. Many different entities must be coordinated to interact seamlessly to result in a single event. There should be enough supplies without having too much that goes to waste. Reservations, scheduling, notification of the event, tallying of the number of guests, lodging, transportation, ceremony accommodations, food, entertainment, cleanup, return of rented clothing and equipment must all be organized.

Many times, the bride chooses to manage the wedding by herself, or with a friend. Since it is likely that a person to go through this event only one to a few times, the planner will not have a great deal of experience in this area. It is common to use a paper calendar book to keep track of information.

The obvious problem with these static paper systems is that there is no logic built into the paper system, there is no search or indexing capabilities, there is no reminder functions and there is no interactive update capability.

In the past, organizations have been hired to orchestrate these events. These services, even though effective, can become very costly.

There are several on-line services which provide a structure and tools to plan one's wedding, such as “theknot.com”. This site provides a location to keep track of much of the information associated with planning a wedding, and is an advancement above paper wedding planning books described above; however, it has its shortcomings.

Since it opens as a blank system, there are no guidelines as to when to begin each task. There are no indications of the costs of tasks, or the relative costs of these tasks. There is also no indication as to which tasks are required to be completed before others begin. All of these features would be beneficial to a user planning a wedding.

Currently, there is a need for an efficient interactive system which would guide a user through the planning and implementation of a wedding.

### SUMMARY OF THE INVENTION

The present invention may be embodied as an interactive wedding planner system which guides a user through planning a wedding comprising:
a) A prestored general plan having a plurality of general modules setting forth the timing, sequencing and financial aspects of a wedding for a given locale;
b) A plan modifier adapted to interact with the user to select desired modules of the general plan, modify the modules according to user input to create a User plan having modules with proposed timing, sequencing and financial information;
c) An input device adapted to interact with said user to receive actual timing, sequencing and financial information and store it in the User plan;
d) A comparator for comparing the actual and proposed timing, sequencing and financial information to create difference information indicating how well the user is performing compared to the User plan; and
e) A reporting device for displays information to said user based upon the difference information.

### OBJECTS OF THE INVENTION

It is an object of the present invention to provide a system which interactively guides a user through a wedding.

It is another object of the present invention to provide an interactive wedding planner which provides a general plan skeleton of costs throughout the wedding process.

It is another object of the present invention to provide an interactive wedding planner system which interactively projects if the user is behind schedule.

It is another object of the present invention to provide an interactive wedding planner system which interactively projects if the user will be over budget.

It is another object of the present invention to provide an interactive wedding planner system which interactively projects guests attending based upon current partial guest responses.

### BRIEF DESCRIPTION OF THE DRAWINGS

A complete understanding of the present invention may be obtained by reference to the accompanying drawings, when considered in conjunction with the subsequent detailed description, in which:

FIG. 1 is a screen shot of one embodiment of an interactive wedding planner according to one embodiment of the present invention.

FIG. 2 is a simplified block diagram of one embodiment of an overall wedding planner according to the present invention.

FIG. 3 is a more detailed block diagram of a portion of the interactive wedding planner shown in FIG. 2.

### DETAILED DESCRIPTION OF THE PRESENT INVENTION

The present invention is a completely interactive, multimedia online wedding planner that combines traditional paper wedding planner with a web-enabled, online guide having vendor directory and search engine functionality. Traditional paper wedding planners help keep a bride organized and on track as they meet two critical needs: (1) they provide helpful lists and suggested timelines and (2) they provide a note taking surface/calendar where brides can keep track of appointments and jot down notes and thoughts while visiting vendors or talking to friends and family. Online vendor directories and/or search engines allow users to access vendor's most updated electronic information any time of day or night.

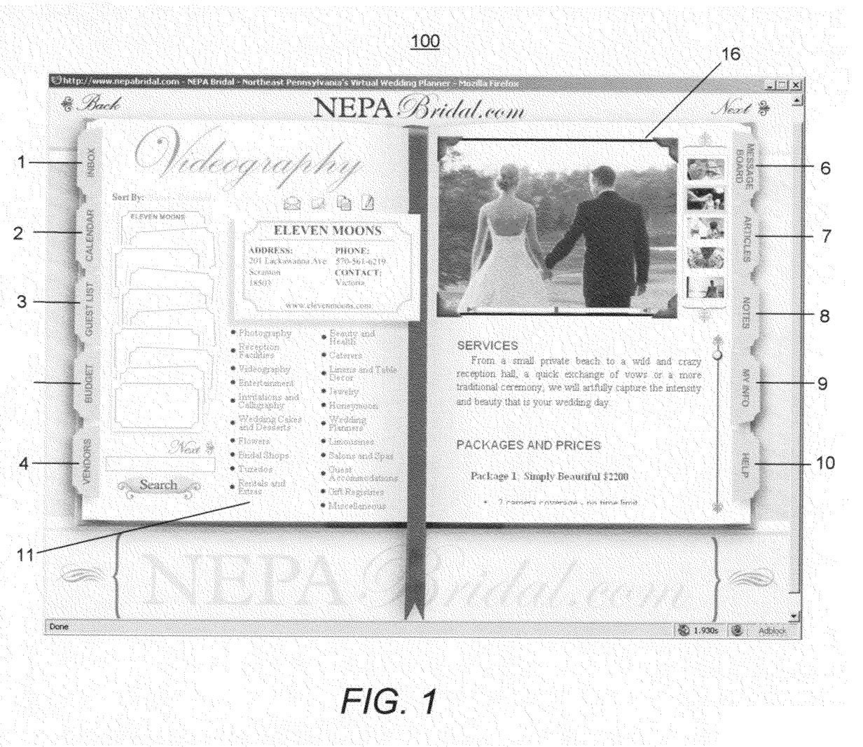

The present invention is a completely interactive virtual wedding planning tool. It combines all the functionalities of a physical paper wedding planner with an online search directory. FIG. 1 is a screen shot of one embodiment of an interactive wedding planner according to one embodiment of the present invention.

The user initializes the system with general information, such as the name, address and contact information of the user.

As will be described below, a general plan of a wedding is pre-programmed into the site which includes the elements common for a wedding (referred to as modules). These modules are either input directly by an Administrator, derived from vendors, derived from the history of past weddings planned on this site, or found by searching on the Internet.

Since the system knows where the user is located, the general plan can use the timing, sequencing and costs for each module related to that locale. For example, the cost associated with renting a hall in New York City differs considerably from that of renting a hall in Scranton, Pa.

The modules consist of one or more tasks to implement the module. Each task has a proposed start date, an indication of tasks which should be completed before this is performed, proposed costs and due dates for various actions including payments.

After initializing the system, the user may then click one of the tabs or other active elements on the website homepage.

The embodiment of the present invention shown in FIG. 1 has an interactive home page 100 interface which consists of 10 tabs:

1. Inbox

2. Calendar

3. Guest List

4. Budget

5. Vendors

6. Message Board

7. Articles

8. Notes

9. Settings

10. Help

Below is an explanation of the functioning of each of the tabs.

Inbox Tab 1

The Inbox Tab 1 shows the interface for a dedicated message inbox which holds all the user's correspondence with wedding vendors, tech support, other website users and suggestions from invited guests. The Inbox tool is used to eliminate e-mails sent to the user's personal e-mail account for three reasons:

1. not to burden users with numerous e-mails for some indefinite period of time;

2. the dedicated inbox increases the impact of the vendor e-mails as they are not alongside many other unrelated e-mails;

3. it increases user traffic to check their in-box, allowing the site to have increased value due to the increased traffic.

Calendar Tab 2

Clicking on the Calendar Tab 2 brings up an interface which guides the user through the tasks that are to be performed.

This pre-programmed calendar is pre-populated with to-do dates of tasks of the modules selected. These dates reflect the common lead times for a wedding in the locale of the user.

This interface also allows users to create, edit and delete appointments from their planner. The display may appear in a three day/four day format with three days on the left side of the planner and four days on the right side. By clicking on the day of your choice a text box appears and users may type as much as they need into the box.

The system identifies when the user is behind schedule for each task. Users can set up the system to automatically send reminders by e-mail and/or to cell phones of the users. The information will be saved in the calendar and can be accessed, edited or deleted at the user's discretion.

Guest List Tab 3

Users will select the guest list tab 3 and enter their entire guest list into the computer including, but not limited to the following information:

first/last name, guest name(s), number in party, e-mail address, meal selection. The guests will be grouped into one of the five categories:

1. Bride's Family

2. Bride's Friend

3. Groom's Family

4. Groom's Friend

5. Bride and Groom's Friend

These may be directly input by the Administrator, or be remotely filled in by the invited guest through a web interface.

For those guests who do not RSVP to paper invitations and/or for those couples wanting to send out electronic invitations to guests, there will be advanced features which allow the e-mail recipients to update planner information. When an e-mail is received and the recipient clicks on “Click here to RSVP” they will be redirected to a page with the following information: Your name, guest's name, meal selection(s), table number. In the event that the person is bringing more than one guest and therefore needs more room, there will be a dropdown menu that allows them additional space. Once the person clicks “Submit” the bride's planner will automatically update and she will receive an e-mail in her inbox. The guests can be viewed using the following criteria: alphabetically, by meal selection or by table number.

The seating chart function tackles one of a bride's greatest concerns—how to arrange her guests in a mutually agreeable manner. Users will choose table characteristics such as round or square, number per table 4, 6, 8, 10 or more and then the present invention will calculate the number of tables based on that information. The tables will appear in a sliding graph with the Table Number above the table and slots for the names underneath. Users will add guests to a particular table by dragging and dropping names from their guest list into the slots. If a user wishes to remove a guest from a particular table, they simply drag the name from the table back to the guest list. To view the next table, simply drag the table in from the right or left or click the arrows at the bottom of the planner. Other user selections may include: “view all tables”, “print list”, etc. A list may include names, table numbers and meal selections.

Since the budget and the timing of many tasks depends upon the number of guests, it is important to estimate the number of guests attending. There are a specific number invited to the wedding; however, some do not respond until some later time, there may be estimates for the number of guest actually attending.

FIG. 4 is a graph of data curves used to estimate attendance according to one embodiment of the present invention. This graph shows a number of curves 1630, 1670, 1690 of the cumulative positive responses to wedding invitations over the period from distribution of the invitations until the wedding day 1610. These curves are constructed by taking actual data from past weddings and adjusting for the total number of invitations and differing time periods between distribution and the wedding date 1610. An average, or most typically curve may be determined which fits the most common responses which may lead to a total at wedding day of a given percentage, such as 70% positive responses at wedding day 1610, which is curve 1670.

Assuming that the shape of the curve is similar but the magnitude changes for the absolute values, additional curves may be constructed. Typical curve 1670 may then be scaled upward to create a 90% curve 1690 or scaled downward to create a 30% curve 1630. It may be scaled to create any number of curves.

These curves are stored for later comparisons.

The number and date of invitations sent are later input to the system. As positive responses are received, they are input to the system with the reception date. The typically curve may then be scaled to match the actual number of cumulative responses received and therefore indicate the total number at the wedding day.

This is important in predicting the number of guests making planning much more exact, resulting in less wasted food, space and supplies.

Budget Tab 4

The interface presented once the user clicks on Budget tab 4 allows brides to keep track of the financial aspects of planning a wedding.

The budget tracker was designed with the idea that although a spreadsheet like form is helpful it can also be overwhelming and cause users to abandon using it. To retain all the utility of a spreadsheet without the overwhelming appearance, the budget tracker is equipped with expandable tabs to hide boxes and columns not currently in use. The following features will be a part of the budget:

A schedule of projected amounts due and their due dates, actual payments made and actual payment dates, differences between the projected amounts and the actual payments to give a running indication of cash flow. Also balance due, a projection of remaining projected costs and remaining cash may be compared to identify how well one is doing compared to the projected budget.

Other items may be calculated and displayed on the budget interface, such as average cost, difference between average and your cost, deposit, 1st payment, 1st payment due date, final payment, final payment due date and payment reminders.

In one embodiment, numbers for the “Average Cost” and “Your Cost” and “Balance Due” will be constantly displayed on this screen. In order to view and edit the other features you must click the expandable arrows and/or click an interactive element entitled “Show all Features.”

As an example for Pennsylvania, “Average Cost will be calculated real-time and adjusted for the Northeastern Pennsylvania region so instead of giving brides National Averages they will be comparing their rates to other couples rates in NEPA. The “Average Cost” will be constantly changing as more information is inputted into the system.

Any “Payment Due Dates” inputted will automatically appear in your calendar.

Payment Reminders can be sent to the cell phone or personal e-mail of your choice.

The budget is printable and all totals will be tallied at the bottom of the screen.

Vendors Tab 5

Clicking on the Vendors tab 5 provides an interface which gives users (brides and grooms) the opportunity to search for companies and or persons that offer the services of their choice.

The Vendors tab 5 interface contains all the information on regional and national vendors in the categories including, but not limited to:
reception facilities, bridal shops, health & fitness, invitations, guest accommodations, caterers, jewelry, salons & spas, photography, entertainment, bars & clubs, tuxedos, dance lessons, videography, ice sculptures & chocolate fountains, wedding cakes & desserts, justice of the peace/officiate, limos and gift registries.

Users may view vendors in each category by clicking on the box containing their name. Vendors are displayed using one of three criteria: 1. alphabetical order, 2. distance from user to vendor (based on zip code), 3. random (this is the default display setting).

Each vendor portfolio may include as many as 1000 pictures and up to 60 minutes of streaming video. Also, by clicking on an “Account Manager” active link and inputting the proper passwords, the vendors can modify their portfolio as often as they like.

Message Board Tab 6

Clicking on “Message Board” tab 6 brings up an interface which allows the administrator, users, vendors to post and read messages in a bulletin board format.

Articles Tab 7

Clicking on the “Articles” tab 7 allows users to read articles dealing with weddings and related subjects to provide guidance to the user.

Notes Tab 8

By clicking on the “Notes” tab 8 an interface pops up which allows the user to open, to store and retrieve personal notes which are not viewable by others on the system. The notes are arranged by date of entry and also include the tab under which it was filed and (when appropriate) the vendor category/name it was placed under. All notes are searchable. For example, one can search for all notes under photography and/or more specifically under a specific photographer's name.

A user is able to search their notes by clicking on an icon next to that vendor's name in the Vendor Tab.

Settings Tab 9

This tab has all the administrative functions for both users and vendors.

Both users and vendors may change the name, address, personal e-mail, phone number, fax number, user name and password fields of this tab.

There will be an optional section in which the user may fill in information for an “Our Story Page” which includes:
“How We Met”
“Our First Date
“How He/She Proposed”
Wedding Date
Bridal Party
And all the other information about the soon to be newlyweds

There will also be the opportunity to upload pictures and video as well as change the background of your planner and add music.

For the vendors: This tab takes the vendors through updating and changing their portfolio. Vendors will be able to edit text in the following fields: services, distinctions, promotions, awards or honors, or any other field they choose to add. Also, vendors will be able to upload pictures and video.

Help Tab 10

The Help tab has standard functionality and features. Users can read about the functions of each tab as well as take advantage of the search tool. A “FAQ” section will also be located under this tab.

Home page 100 has a general category area 11 which lists categories of vendors. These may be, for example, Entertainment, Gift Registries and Photography. Once one is selected, a listing of the companies shows up in a company area 13. For example, if Photography is selected in the vendor category area 11, then a list of Photographer vendors (including XYZ Photography) are listed in company area 13. If XYZ Photography is selected in company area 13, then a pop-up window 15 will show additional information on XYZ Photography and an opposing page 16 will show an advertisement for XYZ Photography with additional information.

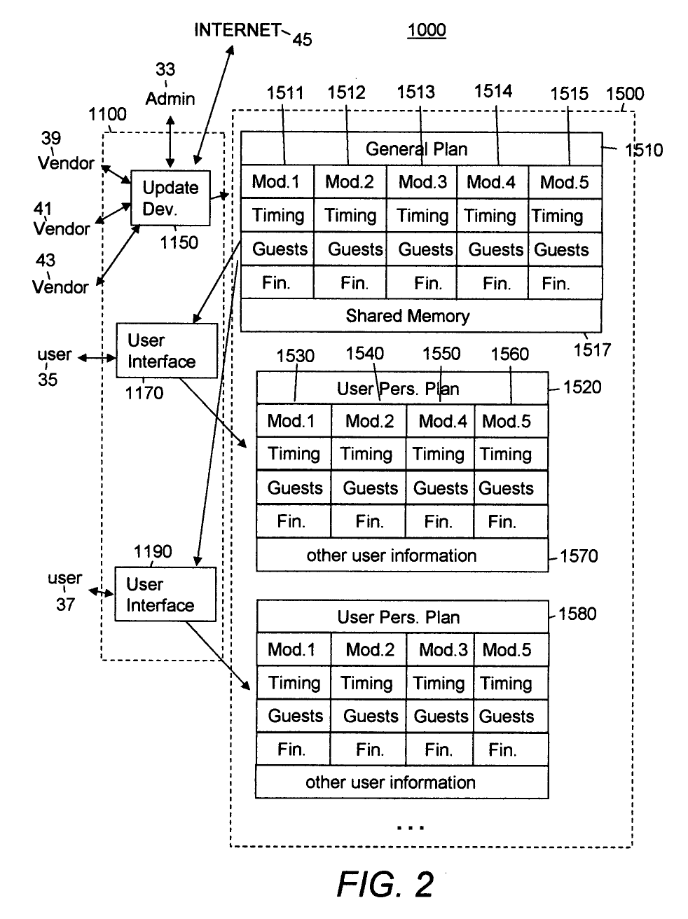

FIG. 2 is a simplified block diagram of one embodiment of an overall wedding planner 1000 according to the present invention.

In order to implement the functions as described above, appropriate hardware/software is required. Interactive programs are running on a server 1100 which allow an administrator 33 to allow vendors 39, 41, 43 to provide information as to their services and costs into a vendor's information section of general information 1510 stored in data storage 1500.

An update device 1150 employs the information from the vendors, information provided by the administrator 33 and other information from the Internet 45 to create a general wedding plan that is representative of an average wedding for the region of intended users. The general wedding plan is prestored in data storage 1500.

General wedding plan is comprised of a plurality of modules 1511, 1512, 1513, 1514, 1515 which represent portions of a wedding plan. Each module is comprised of one or more tasks with each having timing and sequencing considerations. Tasks include a begin date, how long they take and which tasks must be completed before others are performed, if any.

Indications of financial information for each task, such as costs, deposits and cumulative costs common for this locale are included.

An administrator 33 may manually update the data in the general plan through the update device 1150 using information from vendors 39, 41, 43, from the Internet 45 or from other sources. The update device 1150 may also automatically update the general plan using information from these sources.

Users 35, 37, interact with user interfaces 1170, 1190 to customize the general wedding plan by selecting the desired modules and adjusting the timing, sequencing, costs, or other information. In the example in FIG. 2, user 35 selected module 1511, 1512, 1514 and 1515, choosing not to use module 1513. Module 1513 may be, for example, information for setting up a live band for entertainment. If user 35 selected a disk jockey instead, module 1513 does not apply, and is deleted from the plan.

User 37 however, has selected modules 1511, 1512, 1513, and 1515 for the personal plan.

Once the modules are selected, and an estimated number of guests are selected, a wedding plan, complete with a schedule of tasks to be completed, sequencing, and cost information is provided. User 35 may then adjust the plan to personalize it. For example, the cake is budgeted to be 3% of the overall cost. It may be adjusted to 5% of the overall cost. Other amounts may be reduced to cause the overall cost to be the same. If not, the overall cost may increase. All of these costs are interactively calculated and shown to user 37 to allow effective personalization of the plan. Therefore, modules 1511, 1512, 1514, 1515 have been modified by user 35 into modules 1530, 1540, 1550 and 1560, respectively.

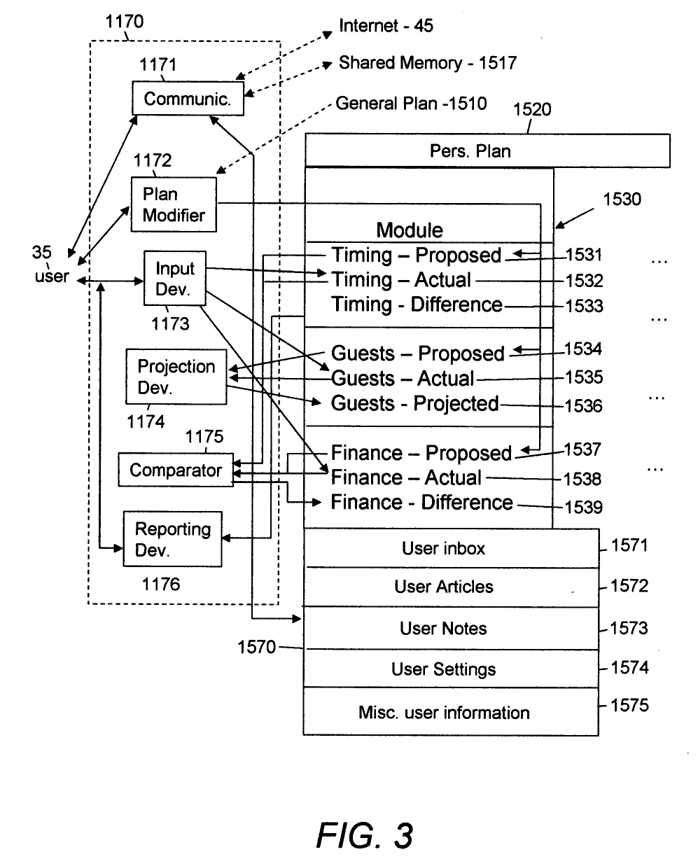

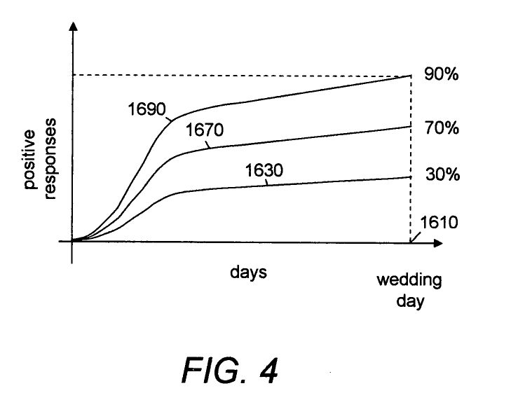

FIG. 3 is a more detailed block diagram of a portion of the interactive wedding planner shown in FIG. 2. In this example, module 1530 is expanded to indicate how the system functions. A plan modification device 1172 has interacted with user 35 to select the proper modules from the general plan, and modified these modules to create the user's personal plan 1520.

As user 35 begins to execute tasks of the user personal plan 1520, user 35 inputs information into module 1530. For example, the actual date in which a task was completed is stored in memory indicated by “timing—actual”, 1532. As each guest sends in a confirmation, the number confirmed and the date the confirmations were received are stored in “guests—actual” 1535. And finally, the amounts paid and their dates paid are stored in “finance—actual” 1538.

An optional projection device 1174 reads the “guests—proposed” 1534 and the “guests—actual” 1535 and projects the total number of guests. This may be done by comparing a graph of the cumulative number of affirmative responses received over time and matching it to prestored curves to estimate the amount of affirmative responses at the wedding day. This number is stored in the “guests—projected” 1536 storage location.

An optional comparator 1175 compares the “timing—proposed” 1531 and “timing—actual” 1532 to determine the difference which is stored “timing difference” 1533. It also compares the “finance—proposed” 1537 and “finance—actual” 1538 to determine the difference which is stored “finance difference” 1539.

A reporting device 1176 collects these differences and provides reports to user 35 based upon the differences. This information may indicate that for this module user 35 is 28% over budget and is one week behind schedule. The timing information may be displayed on a calendar once the calendar tab (2 of FIG. 1) is selected.

The display for this tab (and optionally other tabs having date information) may be in the form of pages of a calendar as described above, or may be in the form of an ongoing timeline, showing events above their corresponding dates.

Input device 1173 interacts with the user 35 to receive and store information relating to “Notes” tab 8 in user notes memory 1573. Input device 1173 also interacts with the user 35 to receive and store information relating to “Settings” tab 9 in user settings memory 1574 according to the description of the settings tab 9 above.

Reporting device 1176 can display any of the stored user information to user 35 in various forms upon request.

A communications device 1171 allows users to search for and read information stored by the vendors in “shared memory” 1517 or the Internet 45 as described above relating to the “Vendor” tab 5.

Similarly, communications device 1171 allows users to search for and read articles on either in shared memory 1517 or in the Internet 45 relating to the “Articles” tab 7. These may be stored in a user's articles memory 1572.

Communications device 1171 allows users to search for and read help in shared memory 1517 relating to the “Help” tab 10.

Communications device 1171 allows users to post messages in shared memory 1517 relating to “Message Board” tab 10. Communications device 1171 also allows users to search for and read messages in shared memory 1517.

Communications device 1171 allows users to receive e-mail from the Internet 45 and store it in a user inbox memory 1571 as described above relating to the “Inbox” tab 5.

While several presently preferred embodiments of the novel invention have been described in detail herein, many modifications and variations will now become apparent to those skilled in the art.

What is claimed is:

1. An interactive wedding planning system which guides a user through planning a wedding comprising:
a) a prestored general plan having a plurality of general modules setting forth the timing, sequencing and financial aspects of a wedding for a given locale;
b) a plan modifier adapted to interact with the user to select desired modules of the general plan, modify the modules according to user input to create a proposed User plan having modules with proposed timing, proposed sequencing and proposed financial information
c) an input device adapted to interact with said user to receive actual timing, actual sequencing and actual financial information and store it in the User plan;
d) a comparator for comparing the actual timing with the proposed timing, the actual sequencing with the proposed sequencing and the actual financial information with the proposed financial information to create difference information indicating how well the user is actually performing compared to the proposed User plan;
e) a reporting device for displaying information to said user based upon the difference information.

2. The interactive wedding planning system of claim 1 further comprising an update device for updating the general plan with new information.

3. The interactive wedding planning system of claim 2 wherein the new information is from the Internet.

4. The interactive wedding planning system of claim 2 wherein the new information is from an administrator.

5. The interactive wedding planning system of claim 2 wherein the new information is from vendor information.

6. The interactive wedding planning system of claim 1 wherein the reporting device is further adapted to provide a graphical display of difference information indicating if the actual timing is ahead or behind the proposed timing.

7. The interactive wedding planning system of claim 1 wherein the reporting device is further adapted to display financial difference information indicating if the actual financial information is above or below the proposed financial information.

8. The interactive wedding planning system of claim 1 wherein the reporting device is further adapted to create reminders notifying said user of the proposed timing indicating tasks to be performed.

9. The interactive wedding planning system of claim 1 wherein the reporting device is further adapted to create warnings notifying said user of the difference information indicating when actual financial information is above proposed financial proposed financial information indicating that a user is over budget.

10. A wedding planner for interacting to a user, the planner adapted to:
a) provide a general wedding structure comprised of a plurality of modules;
b) provide a general timeline for the general wedding structure,
c) provide general costs for the general wedding structure,
d) graphically display the general timeline and the general costs to said user,
e) interact with said user to modify the modules, general timeline, and general costs to result in user modules, user timeline and user costs.

11. An interactive on-line planner for planning a wedding with a plurality of guests, the planner adapted to:
a) provide a proposed timeline of items to be completed;
b) provide an interactive running timeline of items that have been completed;
c) provide a proposed budget of costs of the items;
d) provide interactive actual costs paid;
e) compare the proposed timeline to the running timeline to indicating when items that should be performed; and
f) compare the proposed budget to the actual budget to indicate cost overruns.

12. The interactive on-line planner of claim 11 wherein the timeline indicate items which must be completed before other items begin.

13. The interactive on-line planner of claim 11 wherein the proposed timeline indicates when each item should begin.

14. The interactive on-line planner of claim 11 wherein the proposed budget is dependent upon the number of guests attending.

15. The interactive on-line planner of claim 11 wherein the proposed timeline is dependent upon the number of guests attending.

16. The interactive on-line planner of claim 11 wherein the planner is adapted to interact with said user to receive and store names of guests.

17. The interactive on-line planner of claim 16 wherein the planner is adapted to count the stored names of guests over time and to extrapolate the total number of guests attending the wedding.

18. The interactive on-line planner of claim 11 wherein the planner is adapted to make determinations based upon the extrapolated total number of guests.
